(19) United States
(12) Patent Application Publication
(10) Pub. No.: US 2015/0163212 A1
(43) Pub. Date: Jun. 11, 2015

(54) WORK MACHINE, MANAGEMENT SYSTEM OF WORK MACHINE, AND METHOD OF MANAGING WORK MACHINE

(71) Applicant: KOMATSU LTD., Tokyo (JP)

(72) Inventor: Kaori Saegusa, Yokohama-shi (JP)

(21) Appl. No.: 14/357,630

(22) PCT Filed: Dec. 11, 2013
(86) PCT No.: PCT/JP2013/083264

§ 371 Date: May 13, 2014

(51) Int. Cl. H04L 29/06

(52) U.S. Cl. CPC H04L 63/08

(57) ABSTRACT

A work machine provided with a device configured to execute processing, the work machine includes: a communication terminal device configured to, when the communication terminal device has received a request command for causing the device to execute processing from a command source outside the work machine, return notification of reception completion to the command source, and output the request command to the device that executes processing corresponding to the request command, and transmit processing completion notification indicating the processing has been completed to the command source when the device that executes processing corresponding to the request command executed the processing.

### FIELD

The present invention relates to a work machine, a management system of a work machine, and a method of managing a work machine.

### BACKGROUND

In recent years, a technology to acquire and manage operation information or information related to security of a work machine such as an excavator or a dump truck is known. For example, Patent Literature 1 discloses a technology in which, when security data is registered to a construction machine through a server, a portable input device transmits new security data to the server, the server transmits registered data to the portable input device after registration, the portable input device stores the registration data, an administrator or an operator transmits the new security data from the portable input device on the construction machine to the construction machine, the construction machine collates the security data transmitted from the portable input device and security data stored in a controller of the construction machine, and the construction machine performs remote communication with the server to acquire new security data when inconsistency is caused.

### CITATION LIST

### Patent Literature

Patent Literature 1: Japanese Patent Application Laid-open No. 2002-322685

### SUMMARY

### Technical Problem

To newly register the security data of the construction machine, the administrator or the operator needs to go to the construction machine to perform a registration operation, and thus it may be troublesome. Therefore, for the new registration of the security data, and the like, a demand to cause electronic equipment of the work machine to perform predetermined processing by remote control from an external management device has been increasing. By the way, when processing is requested from the management device to the electronic equipment provided in the work machine by remote control, the electronic equipment of the work machine 1 may not be able to execute the request from the management device if the electronic equipment of the work machine is not ON. As a result, the management device wastefully repeats transmission of the request, and wasteful communication may be caused.

An objective of the present invention is to suppress wasteful communication when a management device requests processing to a device provided in a work machine by remote control.

### Solution to Problem

According to the present invention, a work machine provided with a device configured to execute processing, the work machine comprises: a communication terminal device configured to, when the communication terminal device has received a request command for causing the device to execute processing from a command source outside the work machine, return notification of reception completion to the command source, and output the request command to the device that executes processing corresponding to the request command, and transmit processing completion notification indicating the processing has been completed to the command source when the device that executes processing corresponding to the request command executed the processing.

In the present invention, it is preferable that the work machine comprises: a storage unit configured to store the request command, wherein the communication terminal device causes the storage unit to store the request command before the communication terminal device outputs the request command to the device that executes processing corresponding to the request command, and outputs the request command to the device that executes processing corresponding to the request command at a timing at which the request command is able to be output.

In the present invention, it is preferable that the timing at which the request command is able to be output is a timing after the device that executes processing corresponding to the request command is started, and the device to which the request command has been input executes the processing, and outputs notification indicating the processing has been executed to the communication terminal device after the execution.

In the present invention, it is preferable that the processing is processing of setting an operator who is capable of operating the work machine.

According to the present invention, a work machine provided with a device configured to execute processing, the work machine comprises: a communication terminal device configured to, when the communication terminal device has received a request command for causing the device to execute processing from a command source outside the work machine, return notification of reception completion to the command source, and cause a storage unit to temporarily store the request command, output the request command to the device that executes processing corresponding to the request command after the device is started, and transmit processing completion notification indicating the processing has been completed to the command source when the device that executes processing corresponding to the request command has executed the processing.

According to the present invention, a management system of a work machine, comprises: the work machine provided with a device configured to execute processing; a management device configured to transmit a request command for causing the device to execute processing; and a communication terminal device provided in the work machine, the communication terminal device configured to return notification of reception completion to the management device when the communication terminal device has received the request command from the management device, and output the request command to the device that executes processing corresponding to the request command, and transmit processing completion notification indicating the processing has been completed to the management device when the device that executes processing corresponding to the request command has executed the processing, wherein the management device determines the request command has been received by the work machine when the management device has received the notification of reception completion.

In the present invention, it is preferable that the communication terminal device includes a storage unit configured to store the request command, and causes the storage unit to store the request command before the communication terminal device outputs the request command to the device that executes processing corresponding to the request command, and outputs the request command to the device that executes processing corresponding to the request command at a timing at which the request command is able to be output.

In the present invention, it is preferable that the timing at which the request command is able to be output is a timing after the device that executes processing corresponding to the request command is started, and the device to which the request command has been input executes the processing, and outputs notification indicating the processing has been executed to the communication terminal device after the execution.

In the present invention, it is preferable that the processing is processing of setting an operator who is capable of operating the work machine, and the management device includes a storage unit configured to store a list in which an operator who is capable of operating the work machine is registered, and rewrites the list when the management device has received the processing completion notification.

According to the present invention, a method of managing a work machine comprises: transmitting a request command for causing a device provided in the work machine to execute processing from a command source outside the work machine; returning notification of reception completion to the command source when having received the request command to output the request command to the device that executes processing corresponding to the request command; and transmitting processing completion notification to the command source when the device that executes processing corresponding to the request command has executed the processing.

The present invention can suppress wasteful communication when a management device requests processing to a device provided in a work machine by remote control.

### BRIEF DESCRIPTION OF DRAWINGS

FIG. 1 is a diagram illustrating a site to which a management system of a work machine according to the present embodiment is applied.

FIG. 2 is a diagram illustrating an example of the management system of a work machine according to the present embodiment.

FIG. 3 is a flowchart illustrating a processing procedure of a method of controlling a work machine according to the present embodiment.

### DESCRIPTION OF EMBODIMENTS

Embodiments for implementing the present invention will be described in detail with reference to the drawings.

### Outline of Management System 100

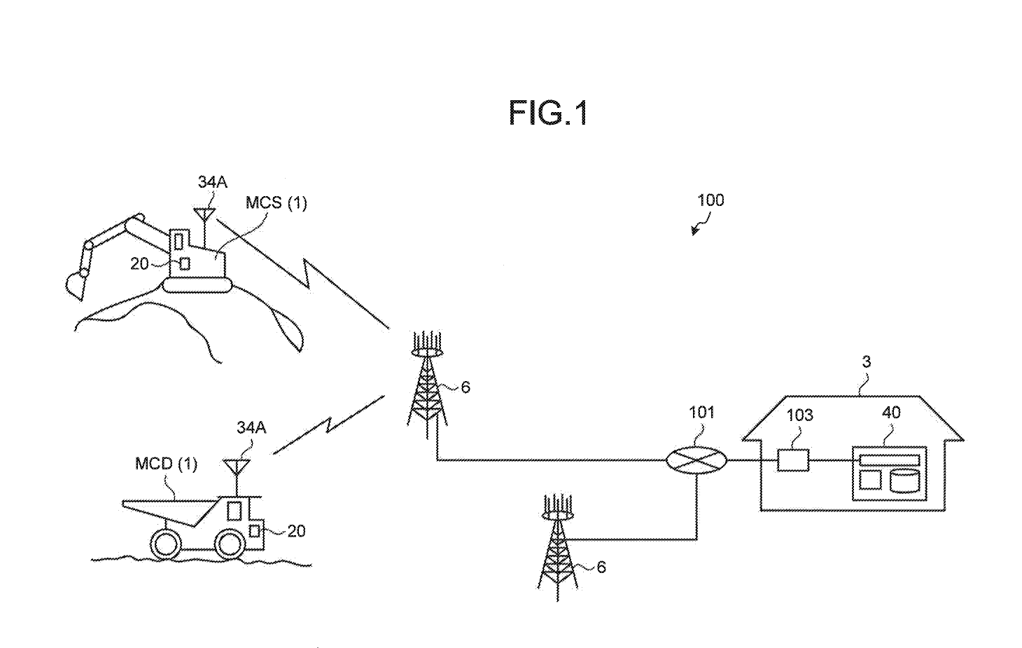

FIG. 1 is a diagram illustrating a site to which a management system 100 of a work machine according to the present embodiment. The management system of a work machine (hereinafter, appropriately referred to as management system) 100 manages a work machine 1 by causing a management device 40 to collect operation information of the work machine 1 through a communication line 101, causing the electronic equipment provided in the work machine 1 and equipment controlled by the electronic equipment (hereinafter, appropriately referred to as electronic equipment, and the like) to execute some sort of processing, and changing setting of the electronic equipment, and the like.

In the example illustrated in FIG. 1, the management system 100 collects operation information of a dump truck MCD and an excavator MCS, and causes electronic equipment and the like hereof to execute some sort of processing. However, in the present embodiment, the work machines are not limited to the example. For example, the management system 100 may manage a wheel loader, a bulldozer, a forklift, or the like. Hereinafter, the dump truck MCD and the excavator MCS are appropriately referred to as work machines 1.

In the management system 100, the management device 40 and a communication terminal device 20 provided in the work machine 1 perform communication through a wireless communication system applied to mobile communication such as mobile phones, a wireless local area network (LAN), or satellite communication. The management device 40 is, for example, installed in a management facility 3. The management facility 3 may be installed in the site in which the work machine 1 operates, or may be installed in a place far from the site in which the work machine 1 operates, for example, a place where a service person who executes preventive maintenance of the work machine 1, and the like, or a place where the administrator of the site stays. Further, the management device 40 may be installed in a predetermined place, or may be a device that can be moved to any place, such as a portable terminal provided with a wireless communication function.

In the present embodiment, the management device is connected to the communication line 101 through a communication device 103. A base station 6 is connected to the communication line 101. The base station 6 relays and transmits various types of information transmitted from a communication device provided in the work machine 1 to the management device 40.

The communication terminal device 20 provided in the work machine 1 receives a processing request command from the management device 40, and transmits, to the management device 40, various types of information or a signal responding to the operation information of the work machine 1 and the above-described processing request command. The communication terminal device 20 transmits information outside through an antenna 34A. The management device 40 receives (acquires) the various types of information transmitted from the communication terminal device 20 of the work machine 1 through the base station 6, the communication line 101, and the communication device 103.

The management device 40 requests processing to the electronic equipment, and the like provided in the work machine 1, and changes setting of functions of the electronic equipment, and the like. In this case, the management device 40 transmits, to the communication line 101, an instruction or information to be transmitted to the work machine 1, through the communication device 103. The instruction or the information is transmitted from the base station 6 in a form of radio wave. The antenna 34A of the work machine 1 receives the radio wave including the instruction or the information transmitted from the base station 6.

The communication terminal device 20 of the work machine 1 executes processing of demodulation and conversion of the radio wave received by the antenna 34A so that the radio wave becomes the original information that can be read by a processing unit 20C of the communication terminal device 20 described below. As described above, the work machine 1, to be more specific, the communication terminal device 20, and the management device 40 can mutually exchange information by wireless communication. Next, the work machine 1, the management device 40, and the management system 100 will be described more detail.

### <Management System 100>

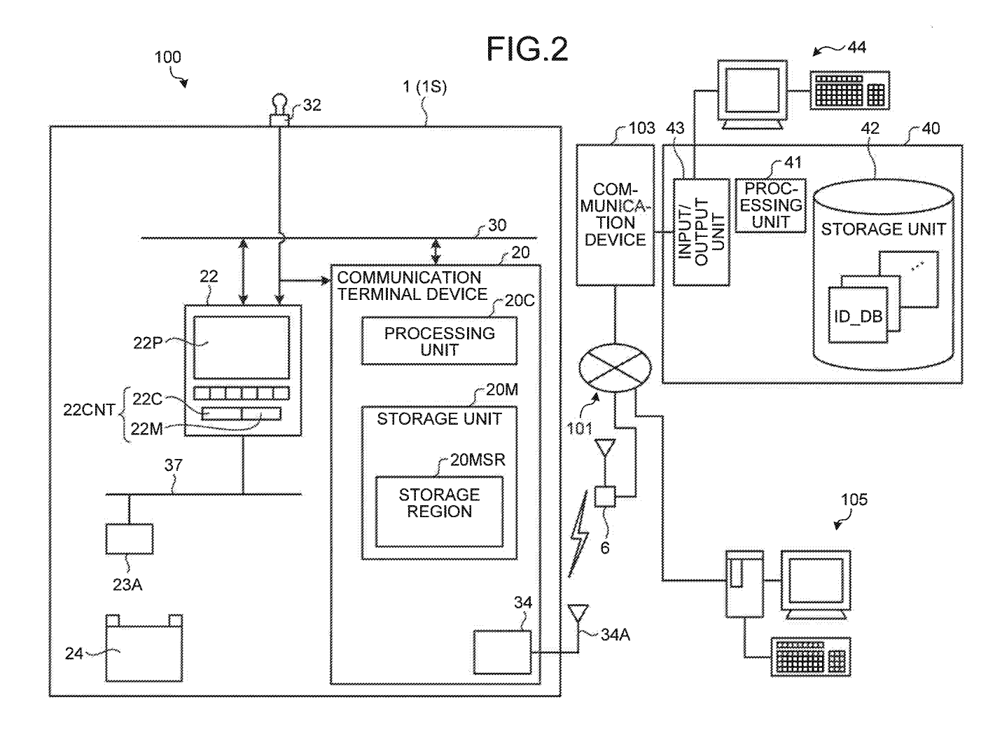

FIG. 2 is a diagram illustrating an example of the management system 100 of the work machine according to the present embodiment. The management system 100 of the work machine includes an on-vehicle system 1S provided in the work machine 1 and the management device 40 provided in the management facility. The on-vehicle system 1S and the management device 40 exchange information through the communication line 101, the communication device 103, and the base station 6.

In the management system 100, the communication terminal device 20 of the on-vehicle system 1S receives (acquires) an instruction or information transmitted from the management device 40 through the communication line 101. The communication terminal device 20 transmits the received instruction or information to the electronic equipment, and the like of the work machine 1 through a signal line 30 provided in the on-vehicle system 1S, and causes the electronic equipment to execute the instruction.

In the present embodiment, for the purpose of illustration, a single work machine 1, a single on-vehicle system 1S, and a single management device 40 are connected through the communication line 101. However, the numbers of the work machine 1 and the management device 40 are not limited. Next, the on-vehicle system 1S will be described.

(on-Vehicle System 1S)

The on-vehicle system 1S includes the communication terminal device 20 and a monitor 22. These pieces of electronic equipment are electrically connected to the signal line 30 provided in the work machine 1. These pieces of electronic equipment connected to the signal line can be communicated with each other. Hereinafter, the signal line 30 provided in the work machine 1 is appropriately referred to as in-vehicle signal line 30. These pieces of electronic equipment provided in the work machine 1 and connected to the in-vehicle signal line 30 are not limited to the above-described example.

A key switch 32 is provided in the vicinity of a driver's seat. The key switch 32 is provided between a storage battery 24 and the pieces of electronic equipment such as the communication terminal device 20 and the monitor 22. Power from the storage battery 24 as a power source provided in the work machine 1 is supplied to the pieces of electronic equipment through the key switch 32. When the key switch 32 is turned ON, the power is supplied from the storage battery 24 to the pieces of electronic equipment. When the key switch 32 is turned OFF, the power supplied from the storage battery 24 to the pieces of electronic equipment is cut off.

When the operator of the work machine 1 operates the key switch 32, the power is supplied from the storage battery 24 to the pieces of electronic equipment of the work machine 1 and a starter motor (not illustrated).

The communication terminal device 20 includes the processing unit 20C, a storage unit (first storage unit) 20M, and a communication unit 34. The processing unit 20C is, for example, a central processing unit (CPU). The storage unit 20M is, for example, a random access memory (RAM), a read only memory (ROM), a flash memory, or a combination thereof. The storage unit 20M stores computer programs in which instructions of processing executed by the communication terminal device 20 are described, information necessary for the processing, and the like. Further, the storage unit 20M temporarily stores the instruction or the information transmitted from the management device 40. A region where the instruction or the information transmitted from the management device 40 is temporarily stored is called storage region 20MSR. The storage region 20MSR is a region where information is freely read and written. The communication unit 34 is ON in a power saving mode even when the key switch 32 is OFF, and can supply the power source of the processing unit 20C to start the processing unit 20C when having received a request command from the management device 40. When the communication unit 34 repeats a period of power source ON and a period of power source OFF at a predetermined cycle in every predetermined time when the key switch 32 is OFF, a control unit of the communication line 101 may retry and transmit the request command to the communication unit 34 at a predetermined cycle until the communication unit 34 receives the request command.

The communication unit 34 is provided with the communication antenna 34A, and can realize wireless communication with the base station 6. The communication unit 34 can exchange information with the management device through the base station 6, the communication line 101, and the communication device 103. The in-vehicle signal line 30 is, for example, a controller area network (CAN).

The monitor 22 is a display device that displays various types of information of the work machine 1 on a screen 22P, and functions as an input device that input an ID number, and the like. The monitor 22 is, for example, a liquid crystal display device, and may be provided with a touch panel as an input device, for example. The input device may be a separate device from the display device of the monitor 22. The monitor 22 is provided with a control device 22CNT for realizing various functions of the monitor 22. The control device 22CNT is provided with a processing unit 22C and a storage unit 22M. The processing unit 22C is, for example, a CPU. The storage unit 22M is, for example, a RAM, a ROM, a flash memory, or a combination thereof. The storage unit 22M stores computer programs in which instructions of processing executed by the processing unit 22C are described, information necessary for the processing, an ID number for identifying an operator who can operate the work machine 1, and the like. In the present embodiment, the monitor 22 performs communication with the communication terminal device 20 through the in-vehicle signal line 30.

In the present embodiment, a second signal line 37 different from the in-vehicle communication line 30 is connected to the monitor 22. The second signal line 37 is, for example, a controller area network (CAN). An ID reader 23A is connected to the second signal line 37. The ID reader 23A performs communication with the monitor 22 through the second signal line 37. In the present embodiment, the ID number is read through the ID reader 23A. However, the ID number may be input through a keyboard or a touch panel provided in the monitor 22.

In the present embodiment, the monitor 22 identifies the input ID number, and manages the operator who can operate the work machine 1, in addition to displaying and inputting of various types of information. The monitor 22 identifies, for example, the operator who can operate the work machine 1 with an ID number given to the operator. Therefore, the storage unit 22M of the control device 22CNT stores an ID number (hereinafter, appropriately referred to as operation permission ID number) that enables the operation of the work machine 1. When an ID number acquired by the control device 22CNT of the monitor 22 through the ID reader 23A accords with the operation permission ID number stored in the storage unit 22M, the processing unit 22C causes the work machine 1 to be in an operable state (unlocked state). When the ID number acquired by the control device 22CNT differs from the operation permission ID number stored in the storage unit 22M, the processing unit 22C causes the work machine 1 to be in an inoperable state (locked state). With such processing, the monitor 22 authorizes the operator who can operate the work machine 1.

An example of processing of when the monitor 22 authorizes the operator will be described. The operator causes the ID reader 23A to read an own ID number, or inputs the own ID number through the keyboard of the monitor 22 in a state where the key switch 32 of the work machine 1 is ON. The acquired ID number is compared with the operation permission ID number stored in the storage unit 22M, in the monitor 22, to be more specific, to be specific, in the processing unit 22C of the control device 22CNT. In the present embodiment, as a means to input the ID number to the ID reader 23A, a dedicated key in which the ID number is registered, or a portable communication terminal device may be used.

When the two ID numbers accord with each other, the processing unit 22C permits start of an engine by an operation of the key switch 32. The processing unit 22C may display, on the screen 22P, information that the operator has been authorized, that is, the work machine 1 is operable. When the acquired ID number and the operation permission ID number do not accord with each other, the processing unit 22C prohibits the start of the engine by an operation of the key switch 32. The processing unit 22C may display, on the screen 22P, information that the operator has not been authorized, that is, the work machine 1 is not operable.

By the operation permission ID number stored in the storage unit 22M of the monitor 22 being rewritten, an ID number that enables the operation of the work machine 1, that is, the operation permission ID number can be changed. In this case, the control device 22CNT of the monitor 22 acquires a newly input operation permission ID number through the communication terminal device 20 and the in-vehicle signal line 30, and rewrites the operation permission ID number stored in the storage unit 22M.

### (Management Device 40)

The management device 40 manages the ID number that enables the operation of the work machine 1, and the like. In the present embodiment, the management device 40 manages a plurality of work machines 1. However, the number of work machines 1 managed by the management device 40 is not limited.

The management device 40 includes a processing unit 41, a storage unit (second storage unit) 42, and an input/output unit 43. The processing unit 41 is, for example, a CPU. The storage unit 42 is, for example, a RAM, a ROM, a flash memory, a hard disk drive, or a combination thereof. The input/output unit 43 performs an input/output of information between the communication device (second communication device) 103 connected to the management device 40 and the processing unit 41.

The communication device 103 is electrically connected to the input/output unit 43 of the management device 40. The communication device 103 is electrically connected with the communication line 101. With such a structure, the management device 40 is connected to the communication line 101 through the communication device 103. The management device 40, to be more specific, the processing unit 41 of the management device 40 receives (acquires) various types of information transmitted from the communication terminal device 20 of the work machine 1 through the communication line 101 and the communication device 103. Further, the processing unit 41 transmits an instruction, information, or the like to the work machine 1 through the communication device 103 and the communication line 101.

Information of the operation permission ID number of the work machine 1, and the like are stored in the storage unit 42 of the management device 40. The operation permission ID number is, for example, described in an ID number database ID_DB created for each work machine 1 managed by the management device 40. The ID number database ID_DB corresponds to a list in which operators who can operate the work machine 1 are registered. The management device 40 inputs a request to rewrite an operation permission ID number of a particular work machine 1 through an input/output device 44 electrically connected to the input/output unit 43. Further, the request to rewrite an operation permission ID number of a particular work machine 1 may be input from a terminal device 105 connected to the communication line 101 other than the management device 40, through the communication line 101 and the communication device 103.

When rewriting the operation permission ID number of the work machine 1, the processing unit 41 of the management device 40 transmits a command to rewrite the operation permission ID number (hereinafter, appropriately referred to as rewriting command) and a new operation permission ID number to the corresponding work machine 1. The communication terminal device 20 of the work machine 1 that has received the rewriting command and the new operation permission ID number transmits the received rewriting command and the new operation permission ID number to the monitor 22 through the in-vehicle signal line 30. The control device 22CNT of the monitor 22 that has received the rewriting command and the new operation permission ID number rewrites the operation permission ID number of the storage unit 22M into the received operation permission ID number. When the operation permission ID number has been rewritten, the communication terminal device 20 transmits notification that the operation permission ID number has been rewritten to the management device 40. When having received the notification that the operation permission ID number has been rewritten from the work machine 1, the processing unit 41 rewrites the operation permission ID number in the ID number database ID_DB. In the present embodiment, rewriting of the operation permission ID number includes rewriting of the ID into a different operation permission ID number, deletion of the existing operation permission ID number, and addition of a new operation permission ID number. When the operation permission ID number is deleted, a rewriting command of deletion and the operation permission ID number to be deleted are transmitted.

When the management device 40 transmits the rewriting command to rewrite the operation permission ID number of the work machine 1 through the communication line 101, there may be a case where the power source of the pieces of electronic equipment provided in the work machine 1 is OFF as a result of the key switch 32 of the work machine 1 being OFF. In this case, the power source of the monitor 22 as the pieces of electronic equipment that rewrites the operation permission ID number is OFF. Therefore, the monitor 22 cannot acquire the rewriting command and the new operation permission ID number received by the communication terminal device 20 and cannot execute processing of rewriting the operation permission ID number. Thus, information that the processing of rewriting the operation permission ID number has been executed is not transmitted from the communication terminal device 20 to the management device 40. Therefore, there is a possibility that the management device 40 continuously transmits the rewriting command, and the like until the management device 40 receives the notification that the processing has been executed transmitted from the work machine 1.

In this case, when the number of times that the rewriting command and the like have been transmitted reaches a predetermined number of times, the management device 40 may determine that the request of the processing has been failed. In addition, until the management device 40 receives the notification that the processing has been executed, which has been transmitted from the work machine 1, the management device 40 cannot recognize the operation permission ID number of the work machine 1 has been rewritten. In this case, it is necessary to send an operator to the site where the work machine 1 that has the operation permission ID number to be rewritten works, and to directly rewrite the operation permission ID number. Therefore, it requires labor. Further, rewriting at the site requires a time, and therefore, the work efficiency may be decreased.

In the present embodiment, when having received a request command for causing a device provided in the work machine 1 to execute processing and data necessary for the execution of the processing, from a command source outside the work machine 1, the communication terminal device 20 returns notification of reception completion of the request command to the command source. The communication terminal device 20 outputs, after confirming the device that executes processing has been started, the request command and the data necessary for the execution of the processing to the device that executes processing corresponding to the request command. When the device has executed the processing, the communication terminal device 20 transmits, to the command source, processing completion notification that indicates the processing has been completed. To be specific, when having received, from the management device 40 outside the work machine 1, a rewriting command that is a request command to cause the monitor 22 provided in the work machine 1 to execute the rewriting processing of the operation permission ID number and the operation permission ID number necessary for the execution of the rewriting processing, the communication terminal device 20 outputs notification of reception completion of the request command to the management device 40. After confirming the monitor 22 has been started, the communication terminal device 20 transmits the rewriting command and the operation permission ID number necessary for the execution of the rewriting processing to the monitor 22. When the monitor 22 has executed the rewriting processing of the operation permission ID number, the communication terminal device 20 transmits, to the management device 40, the processing completion notification that indicates the processing has been completed.

As described above, when having received the request command from the management device 40 installed outside the work machine 1, the communication terminal device 20 transmits the notification of reception completion of the request command to the management device 40. The management device 40 can determine that the request command has been accepted by the communication terminal device 20 by receiving the notification of the reception completion. Therefore, it is not necessary to repeat wasteful transmission of the request command. As a result, the communication terminal device 20 can reduce the wasteful communication when the management device 40 requests processing to the device provided in the work machine 1 by remote control.

It is not necessary for the management device 40 to transmit the request command after grasping whether the power source is supplied to the pieces of electronic equipment provided in the work machine 1. Therefore, the processing of transmitting the request command becomes simple, and the possibility that the timing to transmit the request command is limited to a particular timing can be reduced. Further, it is not necessary for the management device 40 to wastefully repeat the transmission of the request command until the power source is supplied to the pieces of electronic equipment provided in the work machine 1. Further, when the pieces of electronic equipment (in the present embodiment, the monitor 22) that executes the request command has executed the request command, the communication terminal device 20 transmits the processing completion notification to the management device 40. Therefore, the management device 40 can grasp the request command has been executed.

It is not necessary to rewrite the operation permission ID number at the site while operating the monitor 22 of the work machine 1, and the like. Therefore, it is not necessary for the administrator to dispatch an operator to the site where the work machine 1 having the operation permission ID number to be rewritten works. Therefore, the labor to rewrite the operation permission ID number can be reduced, and a decrease in work efficiency can be suppressed. Further, the management device 40 can determine whether the request command has been accepted by the communication terminal device 20 by the reception completion notification. Therefore, the decrease in work efficiency can be suppressed. Further, the management system 100 can rewrite the operation permission ID number by remote control from the management device 40. Therefore, it is not necessary that the operator rewrites the operation permission ID number at the site. Therefore, for example, an owner or the administrator of the work machine 1 can rewrite the operation permission ID number by remote control using the management system 100. Therefore, convenience is enhanced. Next, a processing procedure of a method of managing a work machine according to the present embodiment will be described.

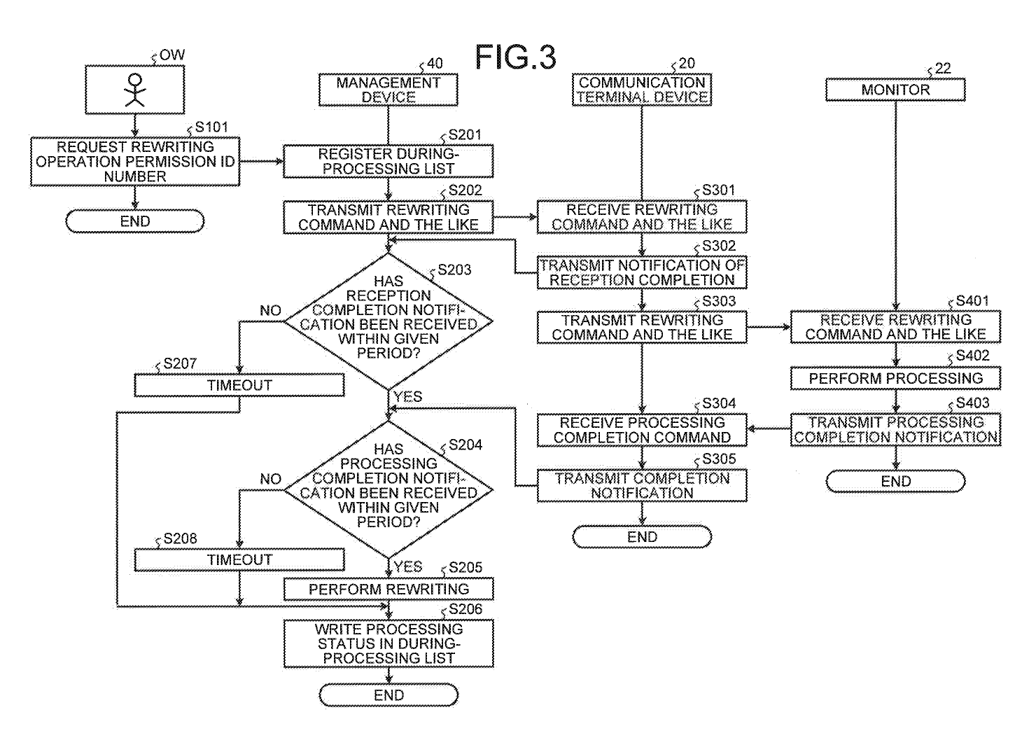

FIG. 3 is a flowchart illustrating a processing procedure of a method of managing a work machine according to the present embodiment. The flowchart illustrates a series of processing executed by an owner OW of the work machine 1, the management device 40, the communication terminal device 20 of the work machine 1, and the monitor 22 of the work machine 1. Hereinafter, while an example of rewriting the operation permission ID number by a request of the owner OW of the work machine 1 will be described, the operation permission ID number may be rewritten by a request of the administrator of the site other than the owner OW, for example.

In step S101, the owner OW transmits the rewriting request of the operation permission ID number from the terminal device 105 illustrated in FIG. 2 to the management device 40 through the communication line 101. The rewriting request includes at least one of a change to a new operation permission ID number, an addition of the new operation permission ID number, and a deletion of the existing operation permission ID number. In step S201, the management device 40 that has received the rewriting request writes, in a during-processing list in the storage unit 42, the processing status is that the rewriting processing of the operation permission ID number is being in execution. Here, the during-processing list is a list of processing that is currently being executed by the management device 40. Next, in step S202, the management device 40 transmits the rewriting command, and the like, to the communication terminal device 20 of the work machine 1 through the communication device 103, the communication line 101, and the base station 6 illustrated in FIG. 2.

In step S301, the communication terminal device 20 of the work machine 1 receives the rewriting command, and the like. In step S302, the communication terminal device 20 transmits the notification of reception completion of the writing command to the management device 40 through the communication unit 34, the base station 6, the communication line 101, and the communication device 103. Further, in step S303, the communication terminal device 20 outputs the rewriting command, and the like received from the management device 40 to the monitor 22 through the in-vehicle signal line 30 illustrated in FIG. 2 after confirming the key switch 32 is ON by checking the power has been supplied to the monitor 22, for example.

The communication terminal device 20 may temporarily store the rewriting command, and the like in the storage unit 20M when outputting the rewriting command, and the like to the monitor 22. In this case, the rewriting command, and the like are stored in the storage region 20MSR. The communication terminal device 20 outputs the rewriting command, and the like stored in the storage unit 20M to the monitor 22 at a timing at which the rewriting command can be output. The timing at which the rewriting command can be output is, for example, a timing after the monitor 22 has been started, that is, a timing after the power source has been supplied. In this case, the communication terminal device 20 outputs the rewriting command, and the like stored in the storage unit 20M to the monitor 22 when having detected the key switch 32 illustrated in FIG. 2 is turned ON. Accordingly, the communication terminal device 20 can suppress an increase in the number of outputs of the rewriting command, and the like to the monitor 22, thereby to decrease the communication load of the in-vehicle signal line 30. The timing at which the rewriting command can be output is not limited to the above-described timing.

In the present embodiment, the rewriting command, and the like are temporarily stored in the storage unit 20M of the communication terminal device 20. However, the storage is not limited to the above example. The storage unit in which the rewriting command, and the like are temporarily stored may just be provided between the communication terminal device 20 and the monitor 22.

When the key switch 32 is turned ON, the power is supplied from the storage battery 24 illustrated in FIG. 2 to the monitor 22, so that the power source is supplied and the monitor 22 is started. In step S401, the rewriting command, and the like output from the communication terminal device 20 are input to the started monitor 22, to be specific, the control device 22CNT. Next, in step S402, the processing unit 22C of the control device 22CNT executes processing based on the rewriting command, and the like. To be specific, the processing unit 22C rewrites the operation permission ID number stored in the storage unit 22M based on the input rewriting command, and the like. For example, when the rewriting command and a new operation permission ID number have been input, the processing unit 22C writes and stores the new operation permission ID number in the storage unit 22M. Further, the processing unit 22C deletes the operation permission ID number to be deleted from the storage unit 22M when the rewriting command, and the like to delete the existing operation permission ID number have been input. When the processing of step S402 has been executed, the processing unit 22C of the monitor 22 outputs, in step S403, the processing completion notification that the rewriting processing of the operation permission ID number has been completed to the communication terminal device 20 through the in-vehicle signal line 30.

When the rewriting processing of the operation permission ID number has not been normally completed due to some sort of causes, the processing unit 22C of the monitor 22 generates the processing completion notification including information thereof, and outputs the notification to the communication terminal device 20. That is, in the present embodiment, the processing completion notification output from the monitor 22 includes either the processing has been normally completed or the processing has not been normally completed (the same applies thereafter).

In step S304, the processing completion notification output from the monitor 22 is input to the communication terminal device 20. Next, in step S305, the communication terminal device 20 transmits the notification of reception completion and the processing completion notification to the management device 40 through the communication unit 34, the base station 6, the communication line 101, and the communication device 103.

In step S203 after step S202, the management device 40, to be specific, the processing unit 41 determines whether having received the reception completion notification of the rewriting command within a given period. When having received the rewriting command (Yes in step S203), the processing unit 41 moves the processing to step S204.

In step S204, after receiving the reception completion notification of the rewriting command, the processing unit 41 determines whether having received the processing completion notification from the communication terminal device 20 in a given period. When having received the processing completion notification from the communication terminal device 20 (Yes in step S204), the processing unit 41 rewrites, in step S205, the operation permission ID number in the ID number database ID_DB to an operation permission ID number corresponding to the rewriting command, and the like transmitted to the communication terminal device 20 of the work machine 1 in step S202. Next, in step S206, the processing unit 41 of the management device 40 writes “the processing completion notification given, the request succeeded” in the processing status of the during-processing list. With the series of processing, the operation permission ID number is rewritten in both of the work machine 1 and the management device 40.

When having not received the reception completion notification of the rewriting command in a given period (No in step S203), the processing unit 41 determines a timeout in step S207. Next, in step S206, the processing unit 41 writes “no reception response, the request failed” in the processing status of the during-processing list.

In step S204, when having not received the processing completion notification in a given period (No in step S204), the processing unit 41 determines a timeout in step S208 because there has been no response within a given time since the rewriting command, and the like was received by the work machine 1. Next, the processing unit 41 writes, in step S206, “the reception response given, the request failed” in the processing status of the during-processing list. After step S206, the owner OW views the processing status, and determines whether the rewriting request should be transmitted again. Note that, after steps S207 and S208, the processing unit 41 may automatically return to step S201, and execute the subsequent processing again. The determination of the timeout is, for example, transmitted to the terminal device 105 or the input/output device 44 of the management device 40, and notified to the owner OW or the administrator of the management device 40 side.

In the present embodiment, the management device 40 informs the owner OW or the administrator of the management device 40 side of the processing status of the request of rewriting the operation permission ID number according to the following six stage status, for example.

The first stage is a state of during the processing of the request, and is a state in which the management device 40 has received the request of rewriting the operation permission ID number from the owner OW but has not transmitted the request to the work machine 1 yet. Step S201 corresponds to the first stage.

The second stage is a state of during the request, and is a state in which the management device 40 has transmitted the request of rewriting the operation permission ID number to the work machine 1, but the reception completion notification of the rewriting command has not been given from the work machine 1. Steps S202 and S301 correspond to the second stage.

The third stage is a state of the reception response given, and is a state in which the management device 40 has received the notification of the reception completion of the rewriting command from the communication terminal device 20 of the work machine 1. Step S203 corresponds to the third stage.

The fourth stage is a state of the request succeeded, and is a state in which the management device 40 has received, from the communication terminal device 20 of the work machine 1, the processing completion notification that the processing of rewriting the operation permission ID number has been succeeded. Step S204 corresponds to the fourth stage.

The fifth stage is a state of the request failed, and is a state in which the management device 40 has received, from the communication terminal device 20 of the work machine 1, the processing completion notification that the processing of the operation permission ID number has been failed. Step S204 corresponds to the fifth stage.

The sixth stage is a state of the timeout, and is a state in which, after transmission of the request of rewriting the operation permission ID number, no processing completion notification has been given from the communication terminal device 20 or the monitor 22 for a given time. Step S208 corresponds to the sixth stage.

The management device 40 terminates the processing of the request received from the owner OW in any of the first, second, and third stages. About the request to rewrite the operation permission ID number, for example, the request of new registration or deletion, the management device 40 determines the request has been reflected in the monitor 22 of the work machine 1 in the fourth stage, and rewrites the operation permission ID number in the ID number database ID_DB, similarly to the operation permission ID number of the monitor 22. The management device 40 determines the request has not been reflected in the monitor 22 of the work machine 1 in the third stage, and does not rewrite the operation permission ID number in the ID number database ID_DB. The owner OW or the administrator of the management device 40 side can more accurately grasp the progress of the processing by confirming the above-described first to sixth stages in the processing of rewriting the operation permission ID number.

In the present embodiment, the processing executed by the electronic equipment of the work machine 1 has been the processing of changing the operation permission ID number, that is, the processing of setting the operator who can operate the work machine 1 (including a new registration, a change, a deletion, and a setting value change of the function to identify the operator). However, the processing is not limited thereto. The processing executed by the electronic equipment of the work machine 1 may be, for example, a change, an addition, or a deletion of a control parameter of an engine controller or a pump controller.

While the present embodiment has been described, the present embodiment is not limited by the above-described content. Further, the above-described configuration elements include things easily assumed by a person skilled in the art, substantially the same things, and things within so-called a scope of equivalents. In addition, the above-described configuration elements can be appropriately combined. Further, at least one of various omissions, replacements, and changes of the configuration elements can be made without departing from the gist of the present embodiment.

### REFERENCE SIGNS LIST

1 WORK MACHINE
1S ON-VEHICLE SYSTEM
3 MANAGEMENT FACILITY
20 COMMUNICATION TERMINAL DEVICE
20C PROCESSING UNIT
20M STORAGE UNIT
22 MONITOR
22P SCREEN
22CNT CONTROL DEVICE
22C PROCESSING UNIT
22M STORAGE UNIT
23A ID READER
30 SIGNAL LINE (IN-VEHICLE SIGNAL LINE)
32 KEY SWITCH
34 COMMUNICATION UNIT
40 MANAGEMENT DEVICE
41 PROCESSING UNIT
42 STORAGE UNIT
44 INPUT/OUTPUT DEVICE
100 MANAGEMENT SYSTEM
101 SIGNAL LINE
103 COMMUNICATION DEVICE
105 TERMINAL DEVICE

1. A work machine provided with a device configured to execute processing, the work machine comprising:
a communication terminal device configured to, when the communication terminal device has received a request command for causing the device to execute processing from a command source outside the work machine, return notification of reception completion to the command source, and output the request command to the device that executes processing corresponding to the request command, and transmit processing completion notification indicating the processing has been completed to the command source when the device that executes processing corresponding to the request command executed the processing.

2. The work machine according to claim 1, comprising:
a storage unit configured to store the request command,
wherein the communication terminal device causes the storage unit to store the request command before the communication terminal device outputs the request command to the device that executes processing corresponding to the request command, and outputs the request command to the device that executes processing corresponding to the request command at a timing at which the request command is able to be output.

3. The work machine according to claim 2, wherein the timing at which the request command is able to be output is a timing after the device that executes processing corresponding to the request command is started, and the device to which the request command has been input executes the processing, and outputs notification indicating the processing has been executed to the communication terminal device after the execution.

4. The work machine according to claim 1, wherein the processing is processing of setting an operator who is capable of operating the work machine.

5. A work machine provided with a device configured to execute processing, the work machine comprising:
a communication terminal device configured to, when the communication terminal device has received a request command for causing the device to execute processing from a command source outside the work machine, return notification of reception completion to the command source, and cause a storage unit to temporarily store the request command,
output the request command to the device that executes processing corresponding to the request command after the device is started, and
transmit processing completion notification indicating the processing has been completed to the command source when the device that executes processing corresponding to the request command has executed the processing.

6. A management system of a work machine, comprising:
the work machine provided with a device configured to execute processing;
a management device configured to transmit a request command for causing the device to execute processing; and
a communication terminal device provided in the work machine, the communication terminal device configured to return notification of reception completion to the management device when the communication terminal device has received the request command from the management device, and output the request command to the device that executes processing corresponding to the request command, and transmit processing completion notification indicating the processing has been completed to the management device when the device that executes processing corresponding to the request command has executed the processing,
wherein the management device determines the request command has been received by the work machine when the management device has received the notification of reception completion.

7. The management system of a work machine according to claim 6, wherein the communication terminal device includes a storage unit configured to store the request command, and causes the storage unit to store the request command before the communication terminal device outputs the request command to the device that executes processing corresponding to the request command, and outputs the request command to the device that executes processing corresponding to the request command at a timing at which the request command is able to be output.

8. The management system of a work machine according to claim 7, wherein the timing at which the request command is able to be output is a timing after the device that executes processing corresponding to the request command is started, and the device to which the request command has been input executes the processing, and outputs notification indicating the processing has been executed to the communication terminal device after the execution.

9. The management system of a work machine according to claim 6, wherein the processing is processing of setting an operator who is capable of operating the work machine, and
the management device includes a storage unit configured to store a list in which an operator who is capable of operating the work machine is registered, and rewrites the list when the management device has received the processing completion notification.

10. A method of managing a work machine comprising:
transmitting a request command for causing a device provided in the work machine to execute processing from a command source outside the work machine;
returning notification of reception completion to the command source when having received the request command to output the request command to the device that executes processing corresponding to the request command; and
transmitting processing completion notification to the command source when the device that executes processing corresponding to the request command has executed the processing.
